(19) United States
(12) Patent Application Publication
(10) Pub. No.: US 2026/0048853 A1
(43) Pub. Date: Feb. 19, 2026

(54) POWER TRANSMISSION SYSTEM FOR A PROPELLER HUB

(71) Applicant: UBIQ AEROSPACE AS, Trondheim (NO)

(72) Inventors: Shibarchi Majumder, Trondheim (NO); Nicolas Carlo Müller, Trondheim (NO)

(21) Appl. No.: 19/103,675

(22) PCT Filed: Aug. 15, 2023
(86) PCT No.: PCT/EP2023/072461

§ 371 Date: Feb. 13, 2025

(30) Foreign Application Priority Data
Aug. 16, 2022 (GB) 2211942.4

(51) Int. Cl. B64D 41/00; B64C 11/02; B64D 15/12; B64D 35/021

(52) U.S. Cl. CPC B64D 41/00; B64C 11/02; B64D 15/12; B64D 35/021; B64D 2221/00

(57) ABSTRACT

A power transmission system for a propeller hub of an aircraft is described, wherein the power transmission system comprises a hollow inner conductive cylinder configured to be mounted to a rotatable shaft a hollow outer insulating cylinder concentric with the inner conductive cylinder, wherein at least a portion of the outer insulating cylinder is located radially outwardly of the inner conductive cylinder, a conductive element positioned at a first end surface of the outer insulating cylinder, wherein the outer insulating cylinder comprises a bore extending radially outwardly from an inner diameter to an outer diameter of the outer insulating cylinder to house a conductive rod for connecting the inner conductive cylinder to a first electrical terminal; wherein the conductive element is configured to be connectable to a second electrical terminal. An aircraft, such as a UAV, comprising the power transmission is also described.

### BACKGROUND

The present invention relates to a power transmission system for a propeller hub of a propeller, such as a propeller of an aircraft. The power transmission system may be implemented as part of a system also including a propeller and may be provided as a part of an aircraft, such as an unmanned aerial vehicle (UAV).

It is known to use propellers for propulsion of vehicles such as aircraft, including lightweight UAVs, also referred to as drones. UAVs typically employ one main propeller, or a plurality of small propellers distributed about the body of the UAV. The propellers can be mounted in a horizontal configuration to provide lift and/or in a vertical configuration to provide thrust. Each propeller consists of a number of blades and is mounted on a shaft. In electrical systems the propeller is mounted on a shaft which is driven by an electric motor to thereby rotate the propeller.

Ice can build up on the surfaces of aircraft during flight which increases their weight, which leads to a reduction in lift and in worst cases can cause the aircraft to stall. In the case of a propeller, ice can change the profile of the propeller blade, increasing the drag and reducing the lift which leads to a reduction in thrust or lift. Ice formation is especially problematic for UAVs due to their light weight and that ice can interfere with the sensors used to feedback essential information to the autopilot system.

There is therefore a need for de-icing systems on board aircraft, and typically for small-scale UAVs, these icing systems involve electrical heating elements located within the propeller blade to melt the ice. The heating elements require electrical power from the aircraft, and there is a need for the hub itself to be able to transmit this electrical power to the components within the propeller blade, and still allow rotational/mechanical power to be transmitted at the same time.

### SUMMARY

Viewed from a first aspect, there is provided a power transmission system for a propeller hub of an aircraft, the power transmission system comprising: a hollow inner conductive cylinder configured to be mounted to a rotatable shaft; a hollow outer insulating cylinder concentric with the inner conductive cylinder, wherein at least a portion of the outer insulating cylinder is located radially outwardly of the inner conductive cylinder; a conductive element positioned at a first end surface of the outer insulating cylinder; wherein the outer insulating cylinder comprises a bore extending radially outwardly from an inner diameter to an outer diameter of the outer insulating cylinder to house a conductive rod for connecting the inner conductive cylinder to a first electrical terminal; and wherein the conductive element is configured to be connectable to a second electrical terminal.

The first electrical terminal and second electrical terminal may be for the electrical components on a propeller blade mounted to the propeller hub. The rotatable shaft may be the drive shaft for the propeller hub. The power transmission system may be provided in combination with the rotatable shaft, which could have features as discussed below.

The proposed solution allows for effective transmission of electrical power from hollow inner conductive cylinder to the propeller via the conductive shaft extending through the bore of the outer insulating cylinder. This provides an electrical connection to a first electrical terminal at the propeller, which may be a positive terminal or a negative terminal for supplying electrical power to electrical components of the propeller. The conductive element then provides an electrical connection to the second electrical terminal at the propeller, which may be a positive terminal or negative terminal for supplying electrical power to electrical components of the propeller.

The conductive element may be electrically insulated from the inner conductive cylinder by the outer insulating cylinder.

The rotatable shaft may comprise a conductive shaft. The inner surface of the inner conductive cylinder may be configured to be in full contact with the rotatable shaft. The inner conductive cylinder may comprise the same electrical potential as the conductive shaft of the rotatable shaft. Electrical power may be supplied to the inner conductive cylinder via an electrical power source conductively connected via the rotatable shaft. The electrical power source may be located on the aircraft.

This arrangement allows electrical power to be transferred from an electrical source, which may be located on the aircraft, to the inner conductive cylinder of the power transmission system.

The inner conductive cylinder may be formed of any electrically conductive material. For example, the inner conductive cylinder may be formed of metals such as brass, copper, steel, titanium alloys or aluminum.

The outer insulating cylinder may be formed of any non-conductive or electrically insulating material. For example, the outer insulating cylinder may be formed of an insulating polymer such as polytetrafluoroethylene (PET), or other insulating materials such as nylon, ceramic or wood.

The rotatable shaft may comprise at least two co-axial shafts. The at least two co-axial shafts may comprise a hollow outer shaft and an inner shaft. The outer shaft and the inner shaft may be conductive shafts formed of materials such as brass, copper or steel. Thus, the rotatable shaft may comprise an inner conductive shaft and an outer conductive shaft. The inner shaft may be hollow or solid.

The rotatable shaft may comprise an insulator positioned between the inner conductive shaft and the hollow outer conductive shaft. The insulator may therefore insulate the two conductive co-axial shafts.

The inner conductive shaft and hollow outer conductive shaft of the rotatable shaft may be formed of a metal material for providing both electrical conductivity and mechanical strength for transmission of mechanical power. Typical materials may include aluminum, high carbon steel or titanium alloys. The inner conductive shaft and hollow outer conductive shaft may comprise the same material, or may be made of different materials. For example, the hollow outer conductive shaft may be designed to carry the majority of the mechanical load and may therefore be made of a higher strength metal, such as steel or titanium alloy. Meanwhile, the inner conductive shaft may be formed of a lighter weight material such as aluminum or copper.

The insulator may comprise any insulating polymer, for example, polytetrafluoroethylene (PET), nylon, ceramic or wood.

The rotatable shaft may be for transmission of mechanical power to the propeller hub. The rotatable shaft may be a drive shaft for the propeller and may therefore provide rotational mechanical power to the propeller. The rotatable shaft may be configured to be driven by any means, for example, an electric motor.

The rotatable shaft may extend from an aircraft end to a propeller end. At the aircraft end, the rotatable shaft may be configured to connect to one or more electrical couplings of the electrical power source. The propeller end may be arranged to connect electrically and mechanically to the power transmission system of the first aspect.

At the aircraft end the hollow outer shaft of the rotatable shaft may be configured to connect to a first electrical terminal of the electrical couplings of the electrical power source. The inner conductive shaft of the rotatable shaft may be configured to connect to a second electrical terminal of the electrical couplings of the electrical power source. The connection between the inner conductive shaft and/or the outer conductive shaft and the electrical couplings may comprise a slip ring arrangement wherein slip rings may comprise brushes or other suitable connectors.

The rotatable shaft may thus have electrical connections to the aircraft end first electrical terminal and aircraft end second electrical terminal, also with physical (conductive) connections made between the rotatable shaft and the aircraft end first electrical terminal and aircraft end second electrical terminal. The rotatable shaft may also have electrical connections to the propeller end first electrical terminal and propeller end second electrical terminal, which may be achieved via the components of the power transmission system. In other words, the electrical connection of the rotatable shaft to the propeller end first electrical terminal may be achieved through the physical (conductive) connection made between the rotatable shaft and the inner conductive cylinder. Likewise, the electrical connection of the rotatable shaft to the propeller end first electrical terminal may be achieved through the physical (conductive) connection made between the rotatable shaft and the conductive element. Therefore, the combination of the rotatable shaft and the power transmission system may provide an electrical connection between the aircraft end first electrical terminal and the propeller end first electrical terminal, and may also provide an electrical connection between the aircraft end second electrical terminal and the propeller end second electrical terminal.

The inner conductive shaft of the rotatable shaft may extend axially beyond the extent of the hollow outer conductive shaft. This arrangement allows the ease of access for the electrical couplings configured to connect to the inner conductive shaft without interfering with the electrical couplings configured to connect to the hollow outer conductive shaft.

The above arrangement provides two electrical pathways along the rotatable shaft, as well as insulation between the two co-axial shafts.

The electrical connections at the aircraft end of the rotatable shaft may be as described in GB2102174.6.

In addition to the two electrical pathways discussed above, the rotatable shaft may further comprise an axial conductive element located within the inner conductive shaft. The axial conductive element may comprise a wire or a conductive tube. The axial conductive element may be embedded within an inner surface of the inner conductive shaft.

The axial conductive element may be for forming optical or digital connections between the aircraft and the propeller blade components. The rotatable shaft may comprise a plurality of axial conductive elements.

The power transmission system may be located at a propeller end of the rotatable shaft. The power transmission system may form the hub of the propeller, or it may form a part of the propeller hub.

As discussed above, hollow inner conductive cylinder of the power transmission system is configured to mount to the rotatable shaft. In particular, the hollow inner conductive cylinder may be configured to mount to the hollow outer conductive shaft of the rotatable shaft.

The hollow inner conductive cylinder may be dimensioned such that the interaction between the hollow inner conductive cylinder and the rotatable shaft forms a tight fit. This may be a press fit or a friction fit. The inner diameter of the inner conductive cylinder may be approximately equal to the outer diameter of the rotatable shaft, i.e., the outer surface of the hollow outer conductive shaft. In operation, there may be no relative movement, either axially or rotationally, between the rotatable shaft and the inner conductive cylinder.

The use of a tight fit between the hollow inner conductive cylinder and the rotatable shaft ensures a constant and reliable electrical connection to the shaft, so that the hollow inner conductive cylinder comprises the same electrical potential as the outer shaft of the rotatable shaft. The inner conductive cylinder may therefore be indirectly connected to the first electrical terminal of the electrical power source of the aircraft.

The bore within the hollow outer cylinder may comprise a circular cross section. As such the bore may be cylindrical in shape. Accordingly, the conductive rod which is configured to be housed within the bore may be cylindrical.

The bore may comprise a threaded inner surface. In this instance, the bore may be configured to house the conductive rod via a screw fit. As such, the conductive rod may comprise a threaded outer surface.

Alternatively, the bore within the hollow outer cylinder may comprise a smooth inner surface. In this case, the bore may be configured to house the conductive rod as a press-fit or friction fit. The conductive rod may therefore comprise a smooth outer surface. Accordingly, the diameter of the bore may be dimensioned such that the interaction between the bore and the conductive rod may form a press-fit or friction.

In a further alternative arrangement, the bore may comprise a cross section of any appropriate shape. For example, the bore may comprise a square or rectangular cross section. In this instance, the conductive rod may also comprise a square or rectangular cross section.

The power transmission system may comprise the conductive rod, wherein the conductive rod may be positioned within the bore. As discussed above, the conductive rod may be positioned within the bore by a screw fit, or alternatively by a press fit or friction fit.

The conductive rod may be configured to be connected to an adapter. As such the conductive rod may be configured to form an electrical connection between the inner conductive cylinder and the adapter. The adapter may be configured to be connectable to the first electrical terminal at the propeller end.

In another arrangement, the conductive rod may be configured to be connectable to the propeller end first electrical terminal directly.

The power transmission system may comprise the adapter, which may be connected to the conductive rod by one of the arrangements discussed herein. The adapter may comprise any conductive material, for example, brass, copper or steel.

The adapter may comprise a cuboid or cylindrical shape. The adapter may comprise at least one opening configured to receive a first end of the conductive rod. The at least one opening may be located within a first side of the adapter.

The at least one opening of the adapter may comprise a shape and/or size which corresponds to the shape and/or size of the conductive rod. The at least one opening may be cylindrical and may have a threaded inner surface. As such, the conductive rod may also be threaded such that the conductive rod and adapter are configured to be connected via a screw fit.

The at least one opening may be cylindrical and comprise a smooth inner surface. As such, the conductive rod may be configured to connect to the adapter via a press fit or friction fit.

In an alternative arrangement, the conductive rod and the adapter may be formed by a single integral piece.

The adapter may be configured to be attached to a connector, which may connect the adapter to the first electrical terminal at the propeller end. The at least one opening of the adapter configured to receive the conductive rod may be a first opening on a first side of the adapter, and the connector may be configured to be located within a second opening on a second end of the adapter, wherein the second end is on the opposite side of the adapter to the first side.

The adapter may comprise a locking mechanism configured to attach the connector to the adapter. The locking mechanism may comprise a screw configured to maintain an end of the connector in position. The screw may be configured to maintain an end of the connector in position via friction forces. The connector may be a conductive wire. In addition, or as an alternative to the locking mechanism, the connector may be soldered to the second side of the adapter, or may be attached with conductive adhesive glue.

The bore may extend from the inner diameter of the outer insulating cylinder to an outer diameter of the outer conductive cylinder. In other words, the bore may extend along the entire thickness of the wall of the outer insulating cylinder from an inner circumference and an outer circumference.

The bore may comprise a first radially inner section dimensioned to house the conductive rod, and the bore may comprise a second outer section dimensioned to house at least a portion of the adapter. The first inner section and the second inner section may form one continuous bore.

The second outer section of the bore may be dimensioned to house the entire length of the adapter.

The first inner section may be located radially inward of the second outer section. As such, the conductive rod may be directly connected to the inner conductive cylinder at a first end and may be directly connected to the adapter at a second end.

A portion of the adapter may be configured to be positioned within the bore, in particular, the second outer section of the bore. As such, a portion of the adapter may be configured to be housed within the outer insulating cylinder, and a portion of the adapter may extend beyond the outer diameter.

In the arrangement where the conductive rod is configured to connect to the propeller end first electrical terminal directly, the bore may comprise a constant cross-sectional area along its length. In this instance, the conductive rod may be directly connected to the inner conductive cylinder at a first end, i.e., for electrical connection to the aircraft end first electrical terminal, and may be directly connected to the propeller end first electrical terminal at the second end.

In addition, the bore may be configured to house the conductive rod, and may therefore be dimensioned accordingly, and the adapter may be configured to be located beyond the outer diameter of the outer insulating cylinder. As such, the bore may comprise a constant cross section to house the conductive rod only.

The power transmission system may be configured such that the conductive rod contacts the radially outer surface of the inner conductive cylinder. Alternatively, the inner conductive cylinder may comprise a cavity. The cavity may be axially aligned with the bore of the outer insulating cylinder such that the cavity may be configured to receive an end of the conductive rod. The cavity may be formed in the outer circumference of the inner conductive cylinder. The cavity may extend a portion of the distance between the outer and inner circumference of the inner conductive cavity.

The cavity may comprise a threaded inner surface such that in the case where the conductive rod is threaded the conductive rod may be connected to the inner conductive cylinder via a screw fit. The cavity may comprise a smooth inner surface such that in the case where the conductive rod is smooth the conductive rod may be connected to the inner conductive cylinder via a press fit or friction fit.

The use of a cavity in the inner conductive cylinder ensures a better connection with the conductive rod, and therefore provides a more reliable electrical connection between the two components.

The cavity may be dimensioned with the same shape and/or size as the bore, and may comprise the same central axis such that the cavity and bore are aligned as discussed above.

The bore may be dimensioned such that the length of the bore is less than the length of the conductive rod. This ensures that a section of the conductive rod extends beyond the inner diameter of the outer insulating cylinder to be housed within the cavity. In addition, the combination of the bore and the cavity may be dimensioned such that the length of the bore and cavity is less than the length of the conductive rod. This ensures that a section of the conductive rod extends beyond the outer diameter of the outer insulating cylinder for contacting the first electrical terminal, or for being housed within the adapter. Alternatively, the combined length of the cavity and the bore may be dimensioned to house the entirety of the conductive rod and at least a portion of the adapter, optionally the entirety of the adapter.

The first electrical terminal on the propeller may be either the positive or the negative terminal of the electrical couplings on the propeller, which may then be correspondingly electrically connected to the first electrical terminal at the aircraft end. This may be used to provide electrical power to components on the propeller, or more specifically the propeller blade. The connector may transfer the electrical power along the length of the propeller blade. Whether the first electrical terminal is the positive or negative terminal may depend on which electrical terminal the outer conductive shaft of the rotatable shaft is connected to at the aircraft end.

The positive and negative terminal may also be termed the primary and secondary terminal respectively. These terms may be used interchangeably throughout.

It will be appreciated that for electrical power transfer, at least two terminals are required. As discussed above, at the aircraft end, the rotatable shaft is connected to first and second (positive and negative) electrical terminals. The negative terminal may also be considered the ground terminal. While the connection to the first electrical terminal of the electrical couplings for the propeller may be achieved by electrical connection through the inner conductive cylinder discussed above, the connection to the second electrical terminal at the propeller end may be achieved by the conductive element.

The conductive element may be attached to the first end surface of the outer insulating cylinder by any connecting means. For example, it may be attached using an adhesive. The conductive element may be attached to the first end surface of the outer insulating cylinder so that it is electrically insulated from the inner conductive cylinder. This prevents any electrical interaction between the inner conductive cylinder and the conductive element which may cause short circuiting of the electrical components.

The conductive element may comprise a conductive wire or winding, and/or may be formed of any electrically conductive material. For example, the conductive element may comprise metals such as brass, copper, steel, titanium alloys or aluminum.

The conductive element may comprise a conductive ring. The conductive ring may comprise an inner diameter and an outer diameter. The conductive ring may comprise a flat disc shape or an annulus, which may comprise a solid volume of electrically conductive material or may have a wound or laminate construction. When viewed from an axial end of the power transmission system, the conductive ring may encircle the inner conductive cylinder.

The conductive ring may extend around the outer circumference of the first end surface of the outer insulating cylinder, such that the outer radius of outer insulating cylinder may be equal to an outer radius of the conductive ring.

The conductive element may be positioned at any radial point on the first end surface of the outer insulating cylinder. In particular, the conductive element may be positioned at a radially outer section of the first end surface of the insulating cylinder.

The conductive element may comprise a conductive segment. The conductive segment may be connectable to the second electrical terminal at the propeller end. The conductive segment may comprise a cube or cuboid shaped conductive segment. The conductive segment may also be termed a conductive block.

The outer insulating cylinder may comprise a recess within the first end surface configured to house the conductive element. The recess allows the conductive element to be more electrically isolated from the inner conductive element. The recess may extend around the circumference of the outer insulating cylinder, which is of specific benefit in the instance where the conductive element is a conductive ring. The recess may comprise a U-shaped cross section comprising a bottom surface and two parallel side walls. The two parallel side walls may include a radially inner side wall and a radially outer side wall.

In the instance where the conductive element is a conductive segment or conductive block, the recess may be a single cavity which may be sized to house the conductive segment.

The recess may be sized such that the conductive element is flush with the first end surface of the outer insulating cylinder.

Alternatively, and as is preferred if the conductive element is a conductive ring, the recess may extend around the outer edge of the outer insulating cylinder at the first end surface such that the recess may only comprise one inner side wall. In this arrangement the radially outer surface of the conductive element may be flush with the radially outer surface of the outer insulating cylinder. This arrangement provides more contact area for a connector to be attached for connecting the conducive element to the second electrical terminal.

The axial length of the outer insulating component may be greater than the axial length of the inner conductive cylinder. In particular the axial length of the inner conductive cylinder may be between 70-90% of the axial length of the outer insulating cylinder.

In addition, the inner diameter of the outer insulating cylinder may vary along its axial length. Specifically, a first portion of the outer insulating cylinder is located radially outward of the inner conductive cylinder as described above. In particular, the inner diameter of the outer conductive cylinder for the first portion of its axial length may be approximately equal to the outer diameter of the inner conductive cylinder. The term approximately in this instance may be interpreted such that the inner conductive cylinder is configured to be located inside the outer insulating cylinder using a press fit or friction fit. The term approximately therefore accounts for any tolerances required.

The first portion of the axial length of the outer cylinder for which the inner diameter of the outer insulating cylinder is approximately equal to the outer diameter of the inner conductive cylinder may be equivalent to the axial length of the inner conductive cylinder.

The remaining portion of the axial length of the outer insulating cylinder may be termed a second portion. The inner diameter of the outer insulating cylinder for the second portion may be equal to the inner diameter of the inner conductive cylinder. Accordingly, the inner diameter of the second portion of the outer insulating cylinder may be approximately equal to the outer diameter of the rotatable shaft. The term approximately equal to may have the same meaning as for the first portion above.

The difference in radius between the first portion and the second portion of the outer insulating cylinder may form a step. The step may be used to locate the inner conductive cylinder in position. As such, the inner conductive cylinder may extend to a first axially end surface of the outer insulating cylinder, but it may not extend to the second, opposite, axially end surface of the outer insulating cylinder. This arrangement is achieved by the combination of the inner conductive cylinder having a shorter axial length than the outer insulating cylinder, and the step between the first portion and the second portion.

The above arrangement ensures that the inner conductive cylinder is not exposed at one axial end of the inner insulating cylinder. This is beneficial as it means that the inner conductive cylinder is not able to contact the electrically conductive carbon fiber fabric surface of the propeller. In the full assembly, as is discussed in more detail below, the majority of the power transmission system may be covered with the material used for the propeller, which may be a conductive material such as carbon fiber fabric. In this instance, it is desired that this conductive material is not in contact with the inner conductive cylinder of the power transmission system. Due to the fact that the inner conductive cylinder may have a shorter length than the outer cylinder, there will be no contact between the inner conductive cylinder and the conductive material of the propeller at least at one axial end of the power transmission system so there is no risk of electrical energy being transferred directly to the carbon fiber fabric of the propeller from the inner conductive cylinder.

The axial end of the outer insulating cylinder comprising the second portion may therefore form the side of the power transmission system which is in contact with the carbon fiber fabric of the propeller.

While the inner conductive cylinder may be used to transmit electrical power from the outer conductive shaft of the rotatable shaft, the conductive element may be used to transmit electrical power from the inner conductive shaft of the rotatable shaft.

The inner conductive shaft may extend axially beyond the end of the outer conductive shaft. The exposed end of the inner conductive shaft may be connectable to the conductive element such that, in use, the inner conductive shaft and the conductive element may have the same electrical potential.

The power transmission system may comprise a conductive cap. The conductive cap may comprise any electrically conductive material, as described in connection with the inner conductive cylinder. The conductive cap may be mountable to the axial end of the rotatable shaft, or the axial end of the propeller hub.

The conductive cap may comprise a first surface configured to contact the axial end of the inner conductive shaft of the rotatable shaft. In use the conductive cap may comprise the same electrical potential as the inner conductive shaft of the rotatable shaft. The inner conductive shaft may be configured to transmit electrical power from the electrical couplings at the aircraft end to the conductive cap of the power transmission system. More particularly, the inner conductive shaft may be configured to transmit electrical power from the second electrical terminal of the electrical couplings at the aircraft end to the conductive cap of the power transmission system.

The first surface of the conductive cap may comprise a cavity which may be configured to receive the axial end of the inner conductive shaft of the rotatable shaft.

The conductive cap may comprise a circular shape when viewed from the axially end of the rotatable shaft, or axial end of the propeller hub. The conductive cap may comprise an axially extending, circumferential flange. The flange may extend around the radially outer surface of the conductive cap. The flange may extend perpendicularly relative to the first surface of the conductive cap such that the flange may contact the conductive element of the power transmission system. In the case where the conductive element is a conductive ring, the flange may be in contact across the entire exposed surface of the conductive ring.

In the alternative arrangement where the conductive element is a conductive segment or block, the conductive cap may comprise an axially extending member which extends from the first surface of the conductive cap to engage a surface of the conductive segment or block.

As such, the conductive cap may be configured to connect the inner conductive shaft of the rotatable shaft to the conductive element. The conductive element may therefore comprise the same electrical potential as the conductive cap and the inner conductive shaft of the rotatable shaft.

This arrangement may therefore allow electrical power to be transmitted between the second electrical terminal of the electrical power source at the aircraft end to the conductive element of the power transmission system at the propeller end, via the inner conductive shaft of the rotatable shaft and the conductive cap. As the conductive element is then connectable to the second electrical terminal of the electrical coupling at the propeller end, electrical power can be transmitted to the electrical components of the propeller.

The conductive element may be connectable to the second electrical terminal at the propeller end via a connector. The connector may comprise any of the features discussed in connection with the connector for the first electrical terminal above. In particular, the connector may comprise a conductive wire, and the connector may be soldered to the conductive element. Alternatively, the connector may be attached to the conductive element using a conductive adhesive glue. This provides a direct electrical connection between the conductive element and the first electrical terminal of the electrical couplings on the propeller.

It will be appreciated that the above combination of the inner conductive cylinder with the conductive rod and adapter housed within the bore provide connection to a first electrical terminal, while the conductive element provides connection to the second electrical terminal. This provides the necessary connections to the two electrical terminals on the propeller hub in order to deliver the required electrical power to the propeller and provide grounding. The use of the co-axial rotatable shaft described above provide the electrical pathways from the electrical power source on the aircraft to either the inner conductive cylinder, or the conductive cap and conductive element.

The first and second electrical terminals at the aircraft end may be connectable to the first and second electrical terminals at the propeller end of the rotatable shaft through the arrangement of the rotatable shaft and the power transmission system as discussed above.

The electrical components on the propeller may comprise sensing elements for detection of thermal and/or aerodynamic conditions of the propeller. These may be used to detect the presence of icing, or the likelihood of icing occurring. In addition, or as an alternative, the electrical components of the propeller may comprise heating elements, such as a resistive wire or carbon fiber fabric capable of conducting electricity. These may be used to remove ice from the surface of the propeller blade.

The propeller may comprise electrical pathways for the supply of electrical power to the electrical components via the first and second electrical terminals. These pathways may comprise the contact surfaces discussed above as well as conductive materials embedded within the propeller, such as conductive pathways leading to electro-thermal elements for providing heating to the propeller surfaces. Alternatively, or additionally, there may be conductive pathways leading to sensing elements for detection of thermal and/or aerodynamic conditions at the propeller. The propeller may comprise an electrical circuit for providing power to one or both of heating elements and sensing elements and/or for transmission of data from sensing elements.

A distinction should be made between the components of the rotatable shaft and the components of the power transmission system for the propeller. The rotatable shaft may be an elongate shaft and may therefore have a length which is greater than its diameter, typically several times greater. In contrast, one or both of the inner conductive cylinder and the outer insulating cylinder of the power transmission system may have a diameter which is comparable to its length. For example, the diameter of the outer insulating cylinder may be approximately the same as its length, and likewise for the inner conductive cylinder. Alternatively, the diameter of the outer insulating cylinder may be greater than its length, for example, the diameter of the outer insulating cylinder may be between 1.2 and 2 times the length of the outer insulating cylinder. The same proportions may apply to the inner conductive cylinder.

The conductive element may be a first conductive element, and the power transmission system may further comprise a second conductive element.

The second conductive element may be positioned at a second end surface of the outer insulating cylinder. The second end surface may be the surface at the opposite end of the outer insulating cylinder where the first conductive element is located. The second conductive element may comprise any of the features discussed in connection with the first conductive element above. It particular, the second conductive element may be connectable to the second electrical terminal of the electrical couplings on the propeller. Moreover, the second conductive element may be configured to be in contact with a conductive cap in order to obtain the same electrical potential as the inner conductive shaft of the rotatable shaft.

The second conductive element may be a second conductive ring. The second conductive ring may comprise the same features as described in connection with the first conductive ring. Likewise, the second conductive element may comprise a second conductive segment or block, which may comprise any of the features discussed in connection with the first conductive segment or block.

The recess of the outer insulating cylinder may be a first recess, and the outer insulating cylinder may comprise a second recess configured to house the second conductive element. The second recess may comprise any of the features discussed in connection with the first recess above.

The second recess may be located within the second end surface of the outer insulating cylinder.

The power transmission system may comprise a conductive elongate member. The conductive elongate member may connect the first conductive element and the second conductive element. The conductive elongate member may extend along an axial length of the outer insulating cylinder. The outer insulating cylinder may comprise a channel for housing the conductive elongate member. The channel may extend along an axial direction of the outer insulating cylinder. The channel may extend from the first recess in the first end surface to the second recess in the second end surface.

The conductive elongate member may comprise any conductive material, such as those already mentioned above.

The conductive elongate member connecting the first and second conductive elements means that in use both the first conductive element and the second conductive element may have the same electrical potential. In particular, electrical power may be transmitted from the inner conductive shaft of the rotatable shaft to both the first conductive element and the second conductive element. It is therefore possible for either the first conductive element and/or the second conductive element to be connected to the second electrical terminal of the electrical couplings of the propeller.

This is advantageous as it allows the propeller to operate in both the “pusher” and “puller” configuration. This may be of particular benefit during wind-tunnel testing of the propeller where typical set-ups require the propeller to operate in the “puller” configuration, whereby the propeller may be located in front of the motor or engine relative to the direction of the airflow.

Although both the first conductive element and the second conductive element may be connectable to the second electrical terminal, in use only one of the first or second conductive elements may be connected to the second electrical terminal. Hence, the provision of a first and second conductive element may provide the option to set the propeller hub up in either the “pusher” or “puller” configuration as described above.

The outer shaft of the rotatable shaft may be configured to connect to a negative terminal at the aircraft end. Consequently, the inner shaft of the rotatable shaft may be configured to connect to a positive terminal at the aircraft end. Likewise, at the propeller end, the power transmission system according to the first aspect, may allow the outer shaft to connect to the respective negative terminal at the propeller end, and meanwhile the power transmission system may allow the inner shaft to connect to the respective positive terminal at the propeller end. In this arrangement, the outer shaft of the rotatable shaft may form an electromagnetic field (EMF) shield. This prevents the inner shaft from being disrupted by electromagnetic interference or other unwanted noise.

Alternatively, the outer shaft of the rotatable shaft may be configured to connect to the positive terminal and the inner shaft may be configured to connect to the negative terminal. Accordingly, the power transmission system may allow the outer shaft to connect to the negative terminal at the propeller end, and for the inner shaft to connect to the positive terminal at the propeller end.

The power transmission system may comprise a plurality of bores extending radially outwardly from an inner diameter of the outer insulating cylinder, each may be configured to house a conductive rod. For example, the bore may be a first bore, and the power transmission system may further comprise a second bore, optionally a third, and optionally a fourth bore.

Each bore of the plurality of bores may comprise any of the features described in connection with the first bore above. In particular, each bore of the plurality of bores may be configured to house a conductive rod which may be for connecting the inner conductive cylinder to a first electrical terminal of a respective propeller blade. The number of bores may correspond to the number of propeller blades on the propeller. In addition, the power transmission system may comprise a plurality of conductive rods and a plurality of adapters which may be configured to be connected to the conductive rods. Each adapter of the plurality of adapters may be connectable to a first electrical terminal of a respective propeller blade.

The conductive ring may be connectable to a plurality of second electrical terminals. In particular, power transmission system may comprise a plurality of connectors, which may be soldered to the conductive ring or may be attached to the conductive ring via a conductive adhesive glue.

The number of connectors, or number of second electrical terminals which the conductive ring is configured to be connectable to, may correspond to the number of bores within the outer insulating cylinder.

As an alternative arrangement, the conductive element may comprise a plurality of conductive segments or blocks, wherein each conductive segment may be a separate piece. In the case of the power transmission system comprising a first conductive element and a second conductive element, each of the first and second conductive elements may comprise a plurality of conductive segments or blocks.

The plurality of conductive segments may each be located at the same radial distance from the center of the outer insulating cylinder. The plurality of conductive segments may be located at different circumferential points around the outer insulating cylinder.

Each conductive segment of the plurality of conductive segments may be connectable to the second terminal of a respective propeller blade at the propeller end.

The conductive cap may therefore comprise a plurality of axially extending portions each configured to engage with a surface of a respective conductive segment of the plurality of conductive segments.

The presence of a plurality of bores and a plurality of connectors for the conductive element means that the power transmission system may provide electrical power to a plurality of propeller blades. Within the propeller, each propeller blade may comprise electrical components each with a first electrical terminal and a second electrical terminals. Therefore, a pair of connectors which may be formed by a connector configured to be connected to the conductive rod or adapter and a connector configured to be connected to the conductive element, may provide electrical power to the electrical components, via the electrical terminals, to a single propeller blade on the propeller. In order to transfer electrical power to the electrical components of a second propeller blade, a second pair of connectors, as defined above, are required.

The number of pairs of connectors may therefore correspond to the number of propeller blades on the propeller. For example, on a propeller comprising two propeller blades, the power transmission system may comprise at least two bores as described above. In addition, the conductive element may be connectable to at least two electrical terminals, which may be achieved by attaching at least two connectors to the conductive ring, or providing two conductive segments, each of which are connectable to a separate electrical terminal.

The conductive cap may be controllable such that only a portion of the plurality of axially extending portions engage with the surface of a respective conductive segment for a given period of time. For example, in a case where there may be four conductive segments, three of the axially extending members may be configured to engage with the surface of the respective conductive segment, while the other axially extending member may be configured to not engage with the surface of the respective conductive segment.

Accordingly, the axially extending members may be controllable or movable between a position where they are configured to engage with the surface of the respective conductive segment, and a position where they are configured to not engage with the surface of the respective conductive part. The axially extending members may therefore have a variable or adjustable length. The length may be determined by an actuation device.

The above arrangement means that only a portion of the plurality of conductive segments may comprise the same electrical potential as the conductive cap.

The use of a plurality of conductive segments or blocks is therefore of particular benefit if it is necessary to supply power to each of the propeller blades individually or at different times. It may be possible for only a portion of the plurality of conductive segments to be electrically charged, meanwhile the remainder of the elements are not electrically charged. As such, electrical power may be supplied to only a portion of the propeller blades.

Viewed from a second aspect, there is provided a propeller comprising one or more propeller blades, and a propeller hub, wherein the propeller hub comprises a power transmission system as described in the first aspect above.

The power transmission system may comprise any of the features discussed in connection with the first aspect above.

The power transmission may be covered with the material used for the propeller surface, for example, the power transmission may be covered with carbon fiber fabric. However, the conductive element may be exposed to allow for a connection to the conductive cap. In the case of there being a first conductive element and a second conductive element, both conductive elements may be exposed to allow for connection to their respective conductive caps.

As discussed in the first aspect, the axial length of the inner conductive cylinder may be less than the axial length of the outer insulating cylinder. This arrangement may be to prevent the inner conductive cylinder from being in contact with the conductive surface of the propeller. In particular, the inner conductive cylinder may not extend to the axial end of the outer insulating cylinder which may be covered with the material used for the propeller surface, which may be a conductive material such as carbon fiber fabric.

The number of bores present in the power transmission system may correspond to the number of propeller blades. For example, if the propeller comprises two propeller blades, the power transmission system may comprise two bores as described in the first aspect. Accordingly, the number of each of the features associated with the bore and the resulting connection to the first electrical terminal may correspond to the number of propeller blades. For example, the number of conductive rods, adapters and connectors for said adapters or conductive rods may correspond to the number of propeller blades on the propeller.

In addition, the number of electrical terminal that the conductive element may be configured to be connectable to may correspond to the number of propeller blades. Similarly, the number of conductive segments may correspond to the number of propeller blades.

Viewed from a third aspect, there is provided a method for providing electrical power to a propeller using a power transmission system defined in the first aspect above. In particular, the method may comprise mounting a hollow inner conductive cylinder to a rotatable shaft, mounting a hollow outer insulating cylinder such that it is concentric with the inner conductive cylinder, wherein at least a portion of the outer insulating cylinder is located radially outwardly of the inner conductive cylinder, and providing a conductive element on a first end surface of the outer insulating cylinder, wherein the outer insulating cylinder comprises a bore extending radially outwardly from an inner diameter of the outer insulating cylinder to house a conductive rod for connecting the inner conductive cylinder to a first electrical terminal, and wherein the conductive element is connectable to a second electrical terminal.

The method may comprise providing a conductive rod within the bore such that electrical power may be transmitted between the inner conductive cylinder and the first electrical terminal of the propeller. The method may further comprise connecting the conductive element to the second electrical terminal. In particular, the method may comprise attaching a connector to the conductive element to provide an electrical connection to the second electrical terminal.

The discussion previously has been primarily in relation to the power transmission system, which may form part of a propeller hub, with reference the rotatable shaft and relevant connection to the aircraft via the rotatable shaft. However, it will be appreciated that the present invention may extend to the overall propulsion system.

Accordingly, viewed from a fourth aspect there is provided a propulsion system for a propeller of an aircraft, the propulsion system comprising a rotatable shaft for transmission of mechanical power extending from an aircraft end to a propeller end, aircraft end electrical connection at an aircraft end of the rotatable shaft for connection to first and second electrical terminals of an electrical power source, wherein the shaft comprises an inner conductive shaft connectable to a second electrical terminal of the electrical power source, an outer conductive shaft connectable to a first electrical terminal of the electrical power source, and an insulator positioned between the inner conductive shaft and the outer conductive shaft, and wherein the propulsion system further comprises a power transmission system as described in the first aspect at the propeller end of the rotatable shaft configured to provide electrical connection to the first and second electrical terminals for supplying power to electrical components of the propeller.

The propeller may be as described in the second aspect above.

The power transmission system may comprise any of the features discussed in connection with the first aspect above. In particular, the electrical pathway between the first electrical terminal of the aircraft end and the first electrical terminal of the propeller end may comprise the outer conductive shaft of the rotatable shaft, the inner conductive cylinder of the power transmission system, the conductive rod which may extend through the bore of the outer insulating cylinder, the adapter and the connector for the adapter. Meanwhile, the electrical pathway between the second electrical terminal of the aircraft end and the second electrical terminal of the propeller end may comprise the inner conductive shaft of the rotatable shaft, the conductive cap, the conductive element and the connector for the conductive element.

It will be appreciated from the preceding discussion that the power transmission has particular benefits in the case of electrically powered aircraft, specifically small and/or automated aircraft such as unmanned aerial vehicles (UAVs). UAVs may use a fuel powered engine or may be fully electrical, and the propeller may require an electrical power supply which may be provided by the power transmission system.

Viewed from a fifth aspect, there is provided a UAV system comprising one or more propellers as described in the second aspect, and/or one or more propulsion systems as described in the fourth aspect.

Each of the one or propellers may be powered electrically and/or mechanically by a propulsion system having features as discussed above.

In addition to the aspects discussed above, there is also presented an alternative arrangement for the power transmission system, which may be used in combination with any of the second to fifth aspects above.

In more detail, viewed from a sixth aspect, there is provided a power transmission system for a propeller hub of an aircraft, the power transmission system comprising: a hollow insulating cylinder configured to be mounted to a rotatable shaft; a first conductive element positioned on a first end surface of the insulating cylinder; and a second conductive element positioned on a second end surface of the insulating cylinder; wherein the first conductive element is configured to be connectable to a second electrical terminal of electrical components on a propeller of the aircraft, and the second conductive element is configured to be connectable to a first electrical terminal of electrical components of a propeller of the aircraft.

The above aspect differs from that of the first aspect in that the inner conductive cylinder and the bore extending radially from the inner diameter to the outer diameter of the insulating cylinder to house a conductive rod have been omitted. Instead, the power transmission system according to the sixth aspect comprises a second conductive element located at the second end of the insulating cylinder element. Aside from the omitted features above, the power transmission system according to the sixth aspect may comprise any of the features discussed in connection with the first aspect above, and the most notable features will be discussed in more detail below.

The first electrical terminal and second electrical terminal may be for the electrical components on a propeller blade mounted to the propeller hub. The rotatable shaft may be the drive shaft for the propeller hub. The power transmission system may be provided in combination with the rotatable shaft, which could have features as discussed below.

The rotatable shaft may comprise the same arrangement as discussed in any preceding aspect. Most notably, the rotatable shaft may be arranged to provide two electrical pathways between an aircraft end of the shaft and a propeller end.

In more detail, the rotatable shaft may comprise at least two co-axial shafts. The at least two co-axial shafts may comprise a hollow outer shaft and an inner shaft. The outer shaft and the inner shaft may be electrically conductive shafts formed of any electrically conductive materials such as brass, copper or steel. Thus, the rotatable shaft may comprise an inner conductive shaft and an outer conductive shaft. The inner shaft may be hollow or solid.

The rotatable shaft may comprise an insulator positioned between the inner conductive shaft and the hollow outer conductive shaft. The insulator may therefore insulate the two conductive co-axial shafts.

The rotatable shaft may extend from an aircraft end to a propeller end. At the aircraft end, the rotatable shaft may be configured to connect to one or more electrical couplings of the electrical power source. The propeller end may be arranged to connect electrically and mechanically to the power transmission system of the sixth aspect.

At the aircraft end the hollow outer shaft of the rotatable shaft may be configured to connect to a first electrical terminal of the electrical couplings of the electrical power source. The power transmission system may be located at a propeller end of the rotatable shaft. The power transmission system may form the hub of the propeller, or it may form a part of the propeller hub.

The term “insulating” in relation to this, and any other aspect, should be interpreted as being unable to conduct electricity, i.e., electrically insulating. Conversely, any materials described as “conductive” in this, and any other aspect, should be interpreted as electrically conductive.

The insulating cylinder may be a hollow cylinder and may be formed of any non-conductive or electrically insulating material. For example, the outer insulating cylinder may be formed of an insulating polymer such as polytetrafluoroethylene (PET), or other insulating materials such as nylon, ceramic or wood.

The insulating cylinder may be formed of one or more separate pieces which may be joined together when the insulating cylinder is mounted to the rotatable shaft. Alternatively, the insulating cylinder may be formed as an integral piece which is then mounted to the rotatable shaft.

The insulating cylinder may be sized so that the interaction insulating cylinder and the rotatable shaft forms a tight fit, which may be a press fit or a friction fit. Alternatively, the power transmission system may comprise an inner cylinder concentric with the insulating cylinder. The inner cylinder may be located radially inwardly of the insulating cylinder. The insulating cylinder may therefore be configured to be mounted to the rotatable shaft via the inner cylinder, whereby the inner cylinder may be mounted directly to the rotatable shaft and the insulating cylinder may then be mounted to the outer surface of the inner cylinder. The inner cylinder may be formed of any material, preferably a non-conductive material.

The use of an intermediate inner cylinder may improve the alignment of the insulating cylinder with the shaft. Accordingly, the inner cylinder may be dimensioned such that the interaction between the inner cylinder and the rotatable shaft forms a tight fit. This may be a press fit or a friction fit. The inner diameter of the inner cylinder may be approximately equal to the outer diameter of the rotatable shaft, i.e., the outer surface of the hollow outer conductive shaft. In operation, there may be no relative movement, either axially or rotationally, between the rotatable shaft and the inner cylinder.

Each of the first and second conductive elements may be attached to the respective end surfaces of the insulating cylinder by any connecting means. For example, they may be attached using an adhesive. The conductive elements may be attached to each end surface of the outer insulating cylinder so that it is electrically insulated from the rotatable shaft. This prevents any electrical interaction between the outer conductive shaft of the rotatable shaft and the conductive element which may cause short circuiting of the electrical components.

The conductive elements may comprise a conductive wire or winding, and/or may be formed of any electrically conductive material.

Each of the first and second conductive elements may comprise a conductive ring as described in the first aspect above. The conductive ring may extend in a circumferential direction around the insulating cylinder and may be positioned at any radial point, for example, at an outermost radial point. As an alternative, each of the first and second conductive elements may comprise a conductive segment or block which extends around a portion of the circumference of the insulating cylinder.

The power transmission system may comprise at least one first connector configured to provide an electrical connection between the first conductive element and the second electrical terminal of the electrical components of the propeller. The first connector may be an electrical wire or electrical connector. The first conductive element may therefore be connectable to the second electrical terminal of electrical components by a first electrical wire.

Similarly, the power transmission system may comprise at least one second connector configured to provide an electrical connection between the second conductive element and the first electrical terminal. The second connector may be an electrical wire or electrical connector. The second conductive element may therefore be connectable to the first electrical terminal of electrical components by a second electrical wire.

The number of first and/or second connectors present may correspond to the number of first and/or second electrical terminals present on the propeller. By way of an example, if a propeller comprises two first electrical terminals and two second electrical terminals, then the power transmission system may comprise two first connectors and two second connectors. The number of first and/or second electrical terminals may correspond to the number of propeller blades on the propeller. This may be the case if each propeller blade comprises a separate set of electrical components. Alternatively, the electrical components of each propeller blade may be powered by a single set of terminals, in which case the propeller may only comprise a single first electrical terminal and a single second electrical terminal.

The first electrical terminal on the propeller may be either the positive or the negative terminal of the electrical couplings on the propeller, which may then be correspondingly electrically connected to the first electrical terminal at the aircraft end. This may be used to provide electrical power to components on the propeller, or more specifically the propeller blade. The connector may transfer the electrical power along the length of the propeller blade. Whether the first electrical terminal is the positive or negative terminal may depend on which electrical terminal the outer conductive shaft of the rotatable shaft is connected to at the aircraft end.

The positive and negative terminal may also be termed the primary and secondary terminal respectively. These terms may be used interchangeably throughout.

It will be appreciated that for electrical power transfer, at least two terminals are required. As discussed above, at the aircraft end, the rotatable shaft is connected to first and second (positive and negative) electrical terminals. The negative terminal may also be considered the ground terminal. While the connection to the first electrical terminal of the electrical couplings for the propeller may be achieved by electrical connection through the inner conductive cylinder discussed above, the connection to the second electrical terminal at the propeller end may be achieved by the conductive element.

The first and second conductive elements according to the sixth aspect may comprise any of the features described in relation to the conductive element(s) described in the first aspect.

The insulating cylinder may comprise a first recess within the first end surface. The first recess may be configured to house the first conductive element. In other words, the first conductive element may be housed or located within the first recess. The first recess may be sized such that the first conductive element is flush with the end surface.

Similarly, the insulating cylinder may comprise a second recess within the second end surface. The second recess may be configured to house the second conductive element. In other words, the second conductive element may be housed or located within the second recess. The second recess may be sized such that the second conductive element is flush with the end surface.

The use of the first and second recesses may allow the first and second conductive elements to be better electrically isolated from the outer conductive shaft of the rotatable shaft and other components present on the propeller hub in use.

Each recess may extend in a circumferential direction around the respective end surface at any radial position, preferably the first and/or second recesses may be located at a radial position which is proximate the outer circumference of the respective end surfaces of the SUBSTITUTE SPECIFICATION-CLEAN VERSION (NO NEW MATTER ADDED) insulating cylinder. More specifically, the first and/or second recess may extend in a circumferential direction about the insulating cylinder on the respective end surfaces at a point between 80% and 100% of the radius of the insulating cylinder.

The first and/or second recesses may be spaced radially inward from the outer circumference of the respective end surfaces. This may essentially provide an outer wall surrounding a radially outer edge of the first and second conductive elements. This outer wall may effectively cover the lateral edge of the first and second conductive elements. In other words, in the case where the recesses are sized such that the first and second conductive elements are flush with the respective end surfaces, only the surface of the conductive elements which are flush with the respective end surfaces may be exposed or accessible. This arrangement further improves the electrical isolation of the first and second conductive elements.

Additionally, the first and/or second recesses may comprise any of the features discussed in connection with the recess(es) described in the first aspect.

Most notably, the recess may comprise a U-shaped cross section comprising a bottom surface and two parallel side walls. The two parallel side walls may include a radially inner side wall and a radially outer side wall.

In the instance where the conductive element is a conductive segment or conductive block, the recess may be a single cavity which may be sized to house the conductive segment or block.

The first end of the insulating cylinder may comprise a first flange which may provide the first end surface. The first flange may be an annular flange extending around the circumference of the insulating cylinder at the first end. The first flange may therefore effectively form an annular extension to the first end surface of the insulating cylinder. The first recess may therefore be within the first end surface provided by the first flange.

In addition, the second end of the insulating cylinder may comprise a second flange which may provide the second end surface. The second flange may be an annular flange extending around the circumference of the insulating cylinder at the second end. The second flange may therefore effectively form an annular extension to the second end surface of the insulating cylinder. The second recess may therefore be within the second end surface provided by the first flange.

In this scenario, the insulating cylinder may comprise a varying outer geometry. In particular, each end of the insulating cylinder may comprise a greater diameter than the rest of the insulating cylinder. The insulating cylinder may comprise a central portion having a constant diameter which extends for the majority of the axial length of the insulating cylinder, for example, 80-95% of the axial length of the insulating cylinder. Each end of the insulating cylinder may comprise a diameter which is larger than the radius of the central portion as may be formed by the first and second flange accordingly.

The precise geometry may depend on the size and space constraints of the system. In particular, it may be necessary for other components to be in the vicinity of the power transmission system on the propeller hub. For example, more space may be required in the area surrounding the central portion of the insulating cylinder. Therefore, while the inner diameter of the insulating cylinder may depend on the diameter of the rotatable shaft, or outer diameter of the inner cylinder if present, the outer diameter of the insulating cylinder may be adapted depending on the location of the other components at the propeller hub.

As an alternative, the insulating cylinder may comprise a constant outer diameter along its entire axial length. As a further alternative, the insulating cylinder may comprise a flange at the first end only or the second end only.

As a yet further alternative, the diameter of the central portion of the insulating cylinder may comprise a diameter greater than the ends of the insulating cylinder. In other words, the diameter of the first end and/or second end may be less than the diameter of the central portion, wherein the central portion of the insulating cylinder may be as defined above. In this case, the first and/or second end may comprise a cut-out portion around the circumference of the insulating cylinder.

The insulating cylinder may comprise an aperture arranged to provide access to the first and second conductive elements. In particular, the aperture may be provided through an inner surface of the respective recesses, for example, the aperture may be provided through a bottom surface of the recess or the radially outer wall of the recess. The aperture may extend from the inner surface of the recess to an outer wall of the insulating cylinder. Accordingly, the aperture may provide access to the conductive element housed within the recess from the outer circumferential wall, which may be in addition to the access provided from the end surface of the insulating cylinder.

The apertures may provide access for the one or more connectors which may be used to connect the first and second conductive elements to the second and first electrical terminal respectively. The number of apertures present within each recess is dependent on the number of electrical terminals on the propeller end. The number of electrical terminals may be dependent on the number of propeller blade. For example, each propeller blade may comprise a first electrical terminal and a second electrical terminal, and so for a propeller having two propeller blades, each recess of the insulating cylinder may comprise two apertures providing access for two connectors to each conductive element respectively.

Each of the first conductive element and second conductive element may be connectable to the respective electrical terminals by an electrical wire via the respective apertures.

The power transmission system may be configured to be mounted to the rotatable shaft using an electrically conductive propeller mounting component. When assembled, the electrically conductive propeller mounting component may be arranged to provide an electrical connection between the outer conductive shaft of the rotatable shaft and the second conductive element. In particular, the electrically conductive propeller mounting may be arranged in direct contact with outer conductive shaft and the second conductive element. As such, the second conductive element may comprise the same electrical potential as the outer conductive shaft in use. The power transmission system may therefore provide a first electrical pathway between the first terminal of a power source located at the aircraft end and the first terminal of the electrical components of the propeller. The first electrical pathway may therefore comprise the outer conductive shaft of the rotatable shaft, the electrically conductive propeller mounting, the second conductive element and the one or more second connectors.

An electrically conductive cap may be configured to be mounted at an axial end of the rotatable shaft proximate the propeller end. The electrically conductive cap may be arranged such that when assembled it provides an electrical connection between the inner conductive shaft of the rotatable shaft and the first conductive element. In particular, the inner conductive shaft of the rotatable shaft may extend beyond the axial end of the outer conductive shaft. The electrically conductive cap may be arranged such that it is in direct contact with the inner conductive shaft, specifically the axial end of the inner conductive shaft, and the first conductive element. As such, the first conductive element may comprise the same electrical potential as the inner conductive shaft of the rotatable shaft in use. The power transmission system may therefore provide a second electrical pathway between the second terminal of a power source located at the aircraft end and the second terminal of the electrical components of the propeller. The second electrical pathway may comprise the inner conductive shaft of the rotatable shaft, the electrically conductive cap, the first conductive element and the one or more first connectors.

The electrically conductive cap may comprise any of the features described in relation to the conductive cap described in the first to fifth aspects above.

Most notably, the electrically conductive cap may comprise a first surface arranged in contact with the axial end of the inner conductive shaft. This first surface may be in arranged perpendicular to a longitudinal direction of the rotatable shaft. The conductive cap, preferably the first surface, may comprise a cavity arranged to house the axial end of the inner conductive shaft in use. This aids location and ensures a reliable electrical connection between the inner conductive shaft and the conductive cap.

The electrically conductive cap may further comprise a flange portion which may extend parallel to the longitudinal direction of the rotatable shaft, or perpendicular to the first surface of the electrically conductive cap. The flange portion may be arranged in contact with the first conductive element.

The above arrangement thereby allows the power transmission system to transmit power from an electrical power source at the aircraft end to the electrical components on the propeller via the rotatable shaft. The electrical components on the propeller may be as described in relation to the first aspect of the invention above.

Viewed from a seventh aspect, there is provided a propeller comprising one or more propeller blades, and a propeller hub, wherein the propeller hub comprises a power transmission system as described in the sixth aspect above.

The power transmission of the present aspect may include any of the features discussed in connection with the first aspect above. In addition, the propeller according to the present aspect may comprise any of the features of the propeller described in the second aspect above.

Most notably the power transmission may be covered with the material used for the propeller surface, for example, the power transmission may be covered with carbon fiber fabric. However, at least one surface of each of the first conductive element and second conductive element may be exposed to allow for contact with the electrically conductive cap and electrically conductive propeller mounting component respectively.

Furthermore, the number of connectors provided for each conductive element, and optionally the number of apertures provided in each recess, may correspond to the number of propeller blades.

Viewed from an eight aspect, there is provided a method for providing electrical power to a propeller using the power transmission system as described in the sixth aspect above. The method comprises: mounting an insulating cylinder to a rotatable shaft for transmission of mechanical power to the propeller hub; providing a first conductive element on a first end surface of the insulating cylinder; providing a second conductive element on a second end surface of the insulating cylinder; connecting the first conductive element to a second electrical terminal of electrical components on a propeller of the aircraft; and connecting the second conductive element to a second electrical terminal of the propeller of the aircraft.

The discussion previously has been primarily in relation to the power transmission system, which may form part of a propeller hub, with reference the rotatable shaft and relevant connection to the aircraft via the rotatable shaft when the power transmission system is assembled with the overall propulsion system in use. However, it will be appreciated that the present invention may extend to the overall propulsion system.

Accordingly, viewed from a ninth aspect, there is provided a propulsion system for a propeller of an aircraft comprising: a rotatable shaft for transmission of mechanical power extending from an aircraft end to a propeller end, aircraft end electrical connection at the aircraft end of the rotatable shaft for connection to first and second electrical terminals of an electrical power source, wherein the shaft comprises an inner conductive shaft connectable to a second electrical terminal of the electrical power source, an outer conductive shaft connectable to a first electrical terminal of the electrical power source, and an insulator positioned between the inner conductive shaft and the outer conductive shaft, and wherein the propulsion system further comprises: a power transmission system as described in the sixth aspect above at the propeller end of the rotatable shaft configured to provide electrical connection to the first and second electrical terminals for supplying power to electrical components of the propeller from the electrical power source.

The propeller may be as described in the seventh aspect above.

The power transmission system may comprise any of the features discussed in connection with the sixth aspect above.

In particular, the first electrical pathway between the first electrical terminal of the aircraft end and the first electrical terminal of the propeller end may comprise the outer conductive shaft of the rotatable shaft, the electrically conductive propeller mounting component, the second conductive element of the power transmission system, and the one or more connectors arranged to connect the second conductive element to the first electrical terminal of the electrical components of the propeller end. Each of these elements of the first electrical pathway may comprise any of the features described in connection to the same elements in the first and sixth aspects above.

Meanwhile, the electrical pathway between the second electrical terminal of the aircraft end and the second electrical terminal of the propeller end may comprise the inner conductive shaft of the rotatable shaft, which may extend beyond the axial end of the outer conductive shaft, the electrically conductive cap, the first conductive element and the one or more connectors arranged to connect the first conductive element to the second electrical terminal of the electrical components of the propeller.

In more detail, the power transmission system may be arranged to provide a first electrical pathway between the first electrical terminal of the power source at the aircraft end of the rotatable shaft and the first electrical terminal of the electrical components of the propeller, and a second electrical pathway between the second electrical terminal of the power source at the aircraft end of the rotatable shaft and the second electrical terminal of the electrical components of the propeller.

The propulsion system may comprise an electrically conductive propeller mounting component which may be configured to mount the propeller to the rotatable shaft and may provide an electrical connection between the outer conductive shaft of the rotatable shaft and the second conductive element. The electrically conductive propeller mounting component may be arranged in direct contact with the outer conductive shaft of the rotatable shaft and the second conductive element. The electrically conductive propeller mounting component may be arranged to rotate with the rotatable shaft in use such that the relative position of the electrically conductive propeller mounting component and the second conductive element remains constant.

The electrically conductive propeller mounting component may further comprise any of the features described in relation to the electrically conductive propeller mounting component in the sixth aspect.

The propulsion system may comprise an electrically conductive cap mounted at an axial end of the rotatable shaft proximate the propeller end, wherein the electrically conductive cap may be arranged to provide an electrical connection between the inner conductive shaft of the rotatable shaft and the first conductive element. The inner conductive shaft of the rotatable shaft may extend to an axial end beyond the axial end of the outer conductive shaft. The conductive cap may be arranged direct contact with the axial end of the inner conductive shaft and the first conductive element. The electrically conductive cap may comprise a first surface arranged in contact with the axial end of the inner conductive shaft, and a flange portion extending parallel to a longitudinal direction of the rotatable shaft in contact with the first conductive element. The conductive cap comprises a cavity arranged to house the axial end of the inner conductive shaft.

The electrically conductive cap may further comprise any of the features described in relation to the electrically conductive cap component in the sixth aspect.

It will be appreciated from the preceding discussion that the power transmission has particular benefits in the case of electrically powered aircraft, specifically small and/or automated aircraft such as unmanned aerial vehicles (UAVs). UAVs may use a fuel powered engine or may be fully electrical, and the propeller may require an electrical power supply which may be provided by the power transmission system.

Viewed from a tenth aspect, there is provided a UAV system comprising one or more propellers as described in the seventh aspect, and/or one or more propulsion systems as described in the ninth aspect.

Each of the one or propellers may be powered electrically and/or mechanically by a propulsion system having features as discussed above.

### BRIEF DESCRIPTION OF THE DRAWINGS

Certain preferred embodiments of the present invention will now be described, by way of example only, with reference to the following drawings, in which:

FIG. 1 shows a power transmission system;

FIG. 2 shows an exploded view of the power transmission system;

FIG. 3 shows an inner conductive cylinder and associated conductive rods for the power transmission system;

FIG. 4 shows an adapted for connection to the conductive rods of the power transmission system;

FIG. 5 shows a power transmission system;

FIG. 6 shows an exploded view of the power transmission system depicted in FIG. 5; and

FIG. 7 shows a propulsion system for a propeller.

### DETAILED DESCRIPTION

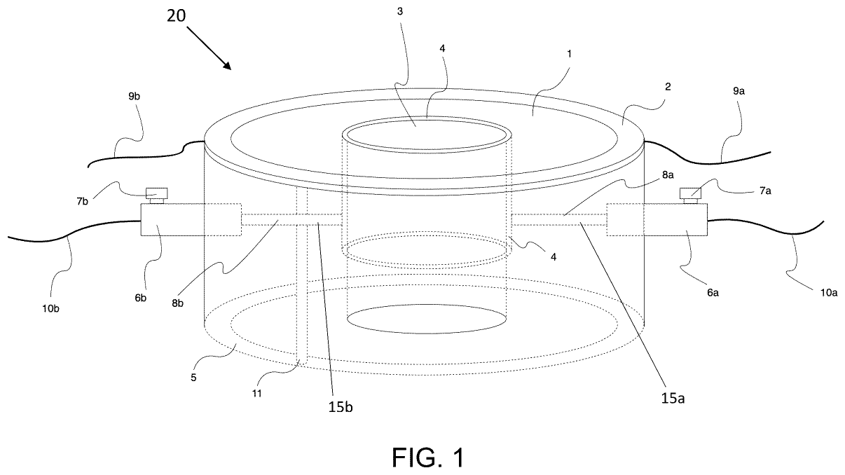

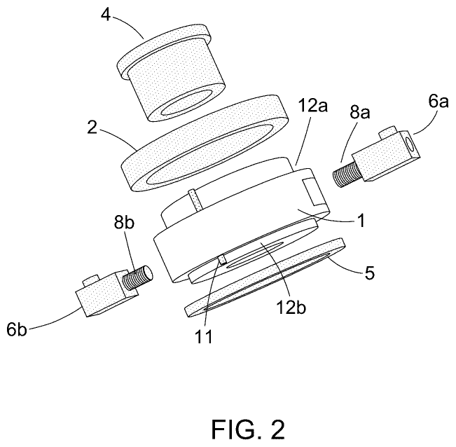

FIG. 1 shows a power transmission system 20 for a propeller of an aircraft, in particular a UAV. The power transmission system 20 forms at least a part of the propeller hub of the propeller. The power transmission system 20 will be described herein with reference to both FIG. 1 and FIG. 2, which shows an exploded view of the power transmission system 20.

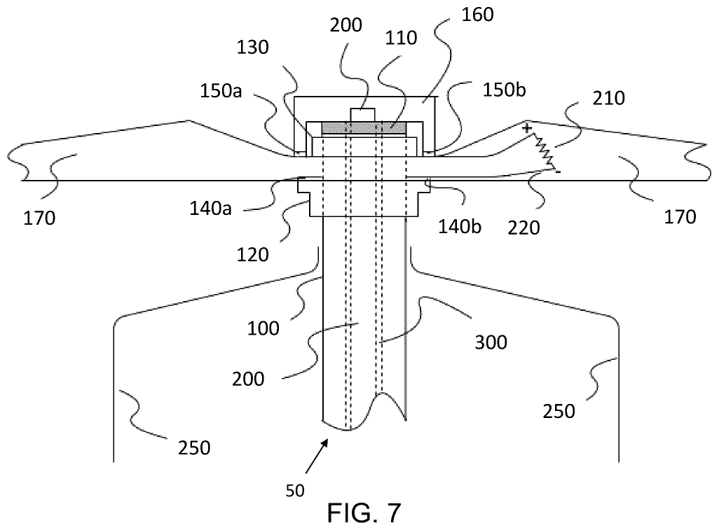

The power transmission system 20 comprises an inner conductive cylinder 4 which is formed of any electrically conductive material. The inner conductive cylinder 4 comprises a central opening 3 for housing a rotatable shaft 50 (see FIG. 7). The rotatable shaft 50 is configured to drive the rotation of the propeller and comprises an aircraft end and a propeller end. The inner conductive cylinder 4 is configured to mount to the rotatable shaft 50 via a press fit or friction fit so that all of the inner surface of the inner conductive cylinder 4 is in contact with the outer surface of the rotatable shaft 50 in use.

The power transmission system 20 comprises an outer insulating cylinder 1. At least a portion of the outer insulating cylinder 1 is located radially outward in relation to the inner conductive cylinder 4. The axial length of the outer insulating cylinder 1 is greater than the axial length of the inner conductive cylinder 4. More specifically, the inner conductive cylinder 4 extends such that it is flush with the top surface of the outer insulating cylinder 1, but it does not extend to the bottom surface of the outer insulating cylinder 1. This prevents the inner conductive cylinder 4 from contacting the conductive surface of the propeller for the complete assembly.

The inner diameter of the outer insulating cylinder 1 varies along its axial length in order to effectively constrain the inner conductive cylinder 4 in position. In particular, the outer insulating cylinder 1 may comprise a first portion equivalent to the axial length of the inner conductive cylinder 4, and a second portion equivalent to the remaining axial length of the outer insulating cylinder 1. The inner diameter of the first portion may correspond to the outer diameter of the inner conductive cylinder 4. As such the inner conductive cylinder 4 may be located within the outer insulating cylinder 1 via a press fit or friction fit. The inner diameter of the second portion corresponds to the outer diameter of the rotatable shaft 50. Therefore, the second portion of the outer insulating cylinder 1 forms a press fit or friction fit about the rotatable shaft 50.

The inner conductive cylinder 4 is formed of any electrically conductive material, such as brass, copper, steel, titanium alloys or aluminum. Meanwhile, the outer insulating cylinder 1 is formed of a non-conductive material such as an insulating polymer, for example, polytetrafluoroethylene (PET), or other insulating materials such as nylon, ceramic or wood.

The power transmission system 20 comprises two bores 15a, 15b which extend radially outwardly from the inner diameter of the outer insulating cylinder 1 towards the outer diameter of the outer insulating cylinder 1. Each bore 15a, 15b houses a conductive rod 8a, 8b.

At a first end, the conductive rods 8a, 8b are connected to the inner conductive cylinder 4. At a second end, the conductive rods 8a, 8b are connected to an adapter 6a, 6b. Each of the adapters 6a, 6b is connected to a connector 10a, 10b, which in this instance is a conductive wire. The connector 10a, 10b is fixed to the respective adapter 6a, 6b by a locking mechanism 7a, 7b, which will be described in more detail below.

The connectors 10a, 10b are each connectable to a first electrical terminal of a respective propeller blade of the propeller. The above arrangement therefore provides an electrical pathway from the inner conductive cylinder 4 to the first electrical terminal.

The power transmission system 20 comprises a first conductive element 2, which in the present example is a first conductive ring 2, located on a first end surface of the outer insulating cylinder 1 and a second conductive element 5, which in the present example is also a second conductive ring 5, located on a second end surface of the outer insulating cylinder 1. The first and second conductive rings 2, 5 are each housed in a respective recess 12a, 12b formed in the outer insulating cylinder 1 (see FIG. 2). Each recess 12a, 12b is dimensioned such that the respective conductive ring 2, 5 is flush with the respective end surface of the outer insulating cylinder 1 and flush with the outer circumferential surface of the outer insulating cylinder 1.

The power transmission system 20 comprises a conductive elongate member 11 which extends from the first conductive ring 2 to the second conductive ring 5. The conductive elongate member 11 extends through a channel along the axial length of the outer insulating cylinder 1.

The conductive elongate member 11 is in direct contact with both the first and second conductive ring 2, 5 to provide an electrical connection between the first and second conductive rings 2, 5 so that they both have the same electrical potential in use. One of the first or second conductive rings 2, 5 is configured to receive electrical power from a portion of the rotatable shaft as will be discussed in more detail in relation to FIG. 7 below.

The first and second conductive rings 2, 5 are each connectable to a second electrical terminal of the propeller blade. Connectors 9a, 9b are connected to the first conductive ring 2 in the arrangement shown in FIG. 1. However, it will be appreciated that the connectors 9a, 9b may be connected to the second conductive ring 5 instead. The two connectors 9a, 9b are configured to connect the first conductive ring 2 to second electrical terminals of two propeller blades respectively. The connectors 9a, 9b may be soldered to the first conductive ring 2, or may be attached by a conductive adhesive glue.

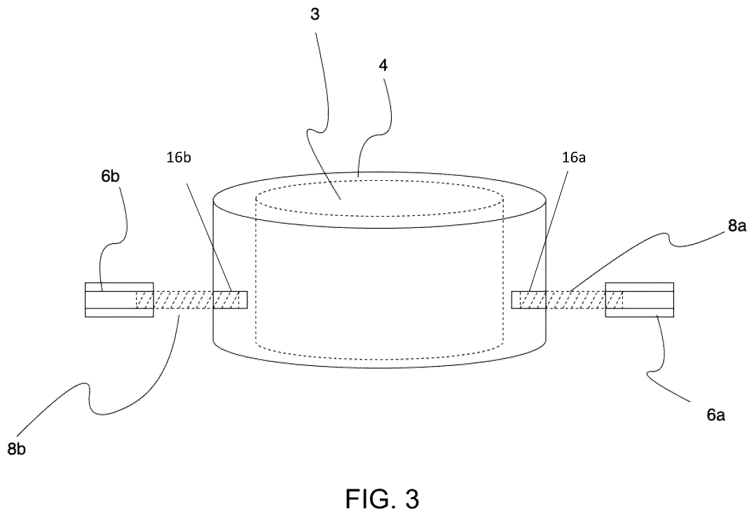

FIG. 3 shows the arrangement of the inner conductive cylinder 4 and the attachment of the conductive rods 8a, 8b. The conductive rods 8a, 8b comprise a threaded outer surface which engages with a threaded inner surface of the bores 15a, 15b. Therefore, the conductive rods 8a, 8b are housed within the bores 15a, 15b via a screw fit. As an alternative arrangement, the conductive rods 8a, 8b may comprise a smooth outer surface, and so the inner surface of the bores 15a, 15b may also be smooth meaning the conductive rods 8a, 8b are housed within the bores 15a, 15b via a press fit or friction fit.

The inner conductive cylinder 4 comprises two cavities 16a, 16b which are aligned with the two bores 15a, 15b. The cavities 16a, 16b are also threaded to allow for the respective conductive rod 8a, 8b to engage with the cavity via a screw fit.

The adapters 6a, 6b comprise a circular through-hole for housing the conductive rods 8a, 8b. As with the cavities 16a, 16b, the circular through-holes are also threaded.

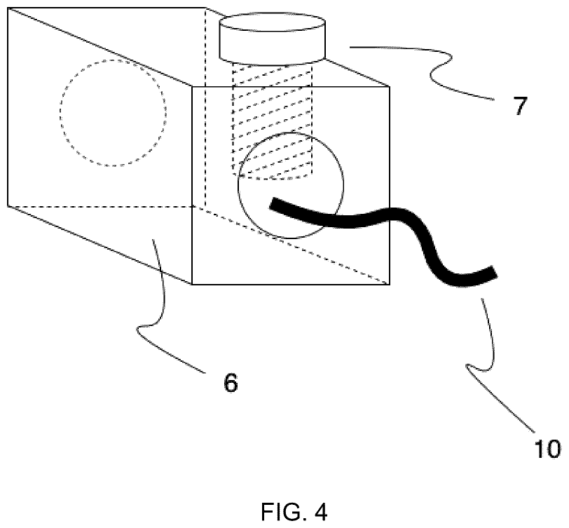

FIG. 4 depicts the arrangement of the adapter 6, specifically the end of the adapter 6 which is attached to the connector 10. As discussed previously, at a first end of the adapter 6, the through-hole forms a first opening for housing an end of the conductive rod 8a, 8b. This allows the adapter to comprise the same electrical potential as the inner conductive cylinder 4. At a second end of the adapter 6, the through-hole forms a second opening as depicted in FIG. 7 for housing the connector 10. The connector 10 in this instance is a conductive wire and connects the adapter 6 to a second electric terminal of the respective propeller blade.

The adapter 6 comprises a locking mechanism 7, which in this case is a screw. The locking mechanism 7 is configured to retain the connector 10 in position. In particular, the locking mechanism 7 may be screwed into the adapter 6 such that the elongate portion of the locking mechanism 7 extends into the internal housing of the adapter 6. An end of the elongate portion of the locking mechanism 7 forces the connector 10 towards an internal wall of the adapter 6 to retain it in position.

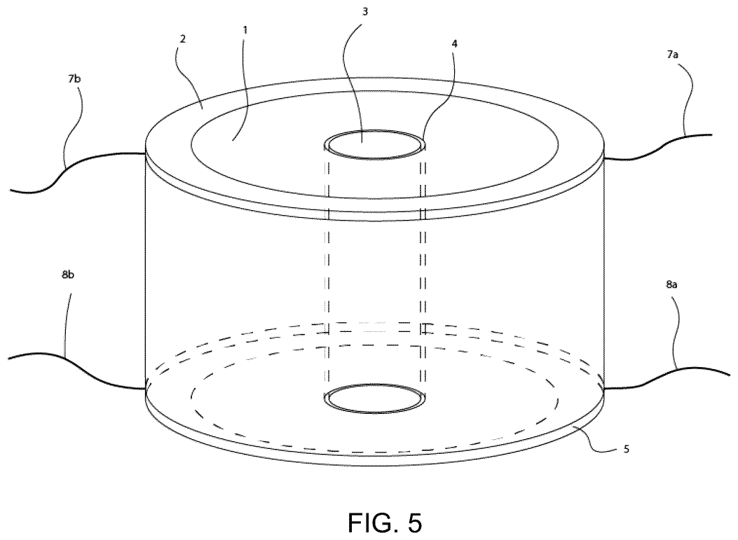

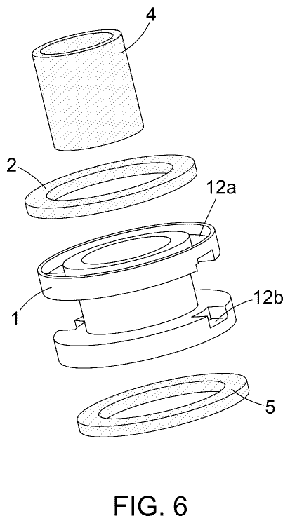

FIGS. 5 and 6 depict an alternative arrangement for the power transmission system formed on a propeller hub. The power transmission system forms at least a part of the propeller hub of the propeller. The power transmission system will be described herein with reference to both FIG. 5 and FIG. 6, which shows an exploded view of the power transmission system.

The power transmission system comprises an inner cylinder 4 which comprises a central opening 4 for housing a rotatable shaft 50. The rotatable shaft 50 is configured to drive the rotation of the propeller and comprises an aircraft end and a propeller end. The inner cylinder 4 is configured to mount to the rotatable shaft 50 via a press fit or friction fit so that all of the inner surface of the inner cylinder 4 is in contact with the outer surface of the rotatable shaft 50 in use.

While in the power transmission system shown in FIGS. 1 and 2, the inner cylinder 4 is formed of an electrically conductive material, the inner cylinder 4 shown in FIGS. 5 and 6 may be formed of any type of material, preferably a material which is not electrically conductive. The inner cylinder 4 for the system of FIGS. 5 and 6 is therefore primarily be to aid mechanical alignment of the system to the rotatable shaft 50, and not to provide electrical conductivity. Accordingly, the inner cylinder 4 of the system in FIGS. 5 and 6 may be considered optional.

The power transmission system comprises an insulating cylinder 1. If the inner cylinder 4 is present, then the insulating cylinder 1 may be considered the outer insulating cylinder 1. The insulating cylinder 1 may be located radially outwardly of the inner cylinder 4, or in the case where the inner cylinder 4 is not present the insulating cylinder 4 may house the rotatable shaft 50 directly.

Either the inner cylinder 4 or the insulating cylinder 1 may be configured to mount to the rotatable shaft 50 via a press fit or friction fit.

The axial length of the insulating cylinder 1 is equal to the axial length of the inner cylinder 4, although it will be appreciated that the axial length of the insulating cylinder 1 may be more or less than the axial length of the inner cylinder 4.

The insulating cylinder 1 is formed of a non-conductive material such as an insulating polymer, for example, polytetrafluoroethylene (PET), or other insulating materials such as nylon, ceramic or wood.

The power transmission system comprises a first electrically conductive element 2, which in the present example is a first conductive ring 2, and a second electrically conductive element 5, which in the present example is a second conductive ring 5. The first conductive ring 2 is located at a first end of the insulating cylinder 1 and the second conductive ring 5 is located at a second end of the insulating cylinder 1.

In the arrangement discussed above in relation to FIGS. 1 to 4, only one of the first and second conductive rings 2, 5 are configured to receive electrical power from a portion of the rotatable shaft. In contrast, in the arrangement in FIGS. 5 and 6, both conductive rings 2, 5 are configured to receive electrical power from a portion of the rotatable shaft as will be discussed in more detail in relation to FIG. 7 below.

Each of the first and second rings 2, 5 are housed in respective recesses 12a, 12b formed in the end surface of the insulating cylinder 1 as depicted in FIG. 6. Each recess 12a, 12b is dimensioned such that the respective conductive ring 2, 5 is flush with the respective end surface of the outer insulating cylinder 1.

In contrast to the power transmission system 20 shown in FIGS. 1 and 2, in the power transmission system shown in FIGS. 5 and 6, a portion of the insulating cylinder 1 forms an outer ring about the circumference of the recesses 12a, 12b. Accordingly, the surface of the first and second conductive rings 2, 5 are only exposed at an end surface of the insulating cylinder 1, and the side surfaces of each of the first and second conductive rings 2, 5 are covered by the material of the insulating cylinder 1.

Although the exploded view shown in FIG. 6 includes recesses 12a, 12b to house the conductive rings 2, 5, the schematic view shown in FIG. 5 does not include said recesses. Instead, the conductive rings 2, 5 are fixed to the respective first and second end surfaces of the insulating cylinder 1 by any available means.

The inner diameter of the insulating cylinder 1 is constant along its axial length so that it is in direct contact with either the inner cylinder 4 or the rotatable shaft 50. However, the outer diameter of the insulating cylinder 1 varies as depicted in FIG. 6. In particular, the insulating cylinder 1 includes a central portion having a constant outer diameter, and a first and second flanged portion located at each axial end of the insulating cylinder 1. Each of the first and second flanged portion have the same outer diameter. The recesses 12a, 12b are formed in the end surface of the flanged portions of the insulating cylinder 1. The first and second conductive rings 2, 5 are therefore located in the flanged portions of the insulating cylinder 1.

It will be appreciated that the precise shape of the insulating cylinder 1 will depend on the other components present on the propeller hub. Accordingly, the outer diameter may be adapted to provide the necessary space for the other essential components present at the propeller hub. Therefore, although depicted with a varying outer diameter in FIG. 6 as described above, the insulating cylinder 1 may comprise a constant outer diameter as shown the schematic version in FIG. 5, or any other outer diameter variation as appropriate.

The first conductive ring 2 may be connectable to a second electrical terminal of the propeller blade. Meanwhile the first conductive ring 5 may be connectable to a first electrical terminal of the propeller blade. In this arrangement, the first electrical terminal may be the positive terminal, and the second electrical terminal may be the negative terminal, or vice versa.

A first set of connectors 7a, 7b are configured to connect the first conductive ring 2 to the second electrical terminal on the propeller blade(s) and a second set of connectors 8a, 8b are configured to connect the second conductive ring 5 to the first electrical terminal on the propeller blade(s). The number of connectors associated with each conductive ring 2, 5 is dependent on the number of propeller blades on the propeller. The first and second connectors are electrical conductive capable of conducting electrical power.

In the present example, the propeller comprises two propeller blades, meaning that one of the first set of connectors 7a, 7b is configured to connect the first conductive ring 2 to a second electrical terminal on a first propeller blade, and the other of the first set of connectors 7a, 7b is configured to connect the first conductive ring 2 to the second electrical terminal on a second propeller blade. Similarly, one of the second set of connectors 8a, 8b is configured to connect the second conductive ring 5 to a first electrical terminal on a first propeller blade, and the other of the second set of connectors 8a, 8b is configured to connect the second conductive ring 5 to the first electrical terminal on a second propeller blade. Each of the first and second connectors 7a, 7b, 8a, 8b are formed of an electrically conductive material, and therefore provide an electrical connection between the electrically conductive elements 2, 5 and the respective electrical terminals on the propeller blade(s).

An inner surface of each of the recesses 12, 12b also comprise one or more apertures which are arranged to allow each of the connectors 7a, 7b, 8a, 8b to be connected to the respective conductive ring 2, 5. The number of apertures present corresponds to the number of connectors required.

FIG. 7 depicts the overall propulsion system for providing both mechanical power and electrical power to a propeller. The power transmission system according to either FIGS. 1 to 4 or FIGS. 5 and 6 may be used in conjunction with the overall propulsion system depicted in FIG. 7 for providing electrical power to a propeller.

The propulsion system includes a rotatable shaft 50 which extends from an aircraft end to a propeller end. The aircraft end comprises a housing 250. The propeller end comprises two propeller blades 170, each comprising electrical components 210 connected by connectors 220 to the power transmission system at the hub of the propeller.

The rotatable shaft 50 comprises an inner conductive shaft 200 and an outer conductive shaft 100. The inner conductive shaft 200 and the outer conductive shaft 100 are separated by an insulator 300. Although not depicted in this instance, the aircraft end of the rotatable shaft is connected to an electrical power source. The outer conductive shaft 100 is connected to a first electrical terminal of the electrical power source via a slip ring arrangement. The inner conductive shaft 200 extends axially beyond the end of the outer conductive shaft 100 so that a portion of the inner conductive shaft 200 is exposed. The inner conductive shaft 200 is then connected to a second electrical terminal of the electrical power source via a slip ring arrangement. Further details regarding the connection at the aircraft end of the rotatable shaft 50 are described in GB2102174.6. This arrangement provides an electrical pathway for both a positive and negative terminal from the aircraft end to the propeller end.

At the propeller end of the rotatable shaft 50, the electrical pathways from the co-axial rotatable shaft 50 to the electrical components 210 of the propeller blades 170 are provided either the power transmission system 20 shown in FIGS. 1 to 4, or by the power transmission system shown in FIGS. 5 and 6.

In the case of the power transmission system 20 depicted in FIGS. 1 to 4, the inner conductive cylinder 4 is in contact with the outer conductive shaft 100 of the rotatable shaft 50. The inner conductive cylinder 4 therefore has the same electrical potential as the outer conductive shaft 100 provided by the first electrical terminal of the electrical power source. The conductive rods 8a, 8b are in contact with the inner conductive cylinder 4 at one end, and in contact with the adapters 6a, 6b at the other end. The adapters 6a, 6b are then connected to the first electrical terminals of the electrical components 210 for each propeller blade 170. This provides an electrical pathway from the first electrical terminal at the aircraft end to the first electrical terminal of the electrical components of the propeller blade.

The inner conductive shaft 200 of the rotatable shaft 50 extends axially beyond the end of the outer conductive shaft 100. The end of the inner conductive shaft 200 is then configured to contact the conductive cap 160. In particular, the conductive cap 160 comprises a cavity configured to house the end of the inner conductive shaft 200. The conductive cap 160 should therefore have the same electrical potential as the second electrical terminal of the aircraft end.

The conductive cap 160 comprises an axially extending circumferential flange 150a, 150b which extends toward the propeller. The circumferential flange 150a, 150b is configured to contact the conductive ring 2 of the power transmission system 20. The conductive ring 2 therefore comprises the same electrical potential as the inner conductive shaft 100 of the rotatable shaft. The conductive ring 2 is then connected to the second electrical terminal of the propeller electrical components 210 via the connectors 9a, 9b. This arrangement provides an electrical pathway between the second electrical terminal of the electrical power source at the aircraft end and the second electrical terminal of the propeller electrical components 210.

In the case of the power transmission system shown in FIGS. 5 and 6, the inner cylinder 4 is formed of a non-conductive material, or may not be present at all in some iterations as it is intended to provide mechanical alignment, not electrical conductivity. Therefore, power transmission system is arranged so that second conductive ring 5 is in direct contact with the propeller mounting component 120. The propeller mounting component 120 is formed of an electrically conductive material and is in direct contact with the outer conductive shaft 100 of the rotatable shaft 50. The conductive ring 5 there has the same electrical potential as the outer conductive shaft 100 provided by the first electrical terminal of the electrical power source. The second set of connectors 8a, 8b are then connected to the first electrical terminals of the electrical components 210 on each propeller blade 170.

This arrangement therefore provides an electrical pathway between the first electrical terminal at the aircraft end to the first electrical terminal of the electrical components of the propeller blade.

The electrical pathway between the second electrical terminal at the aircraft end to the second electrical terminal of the electrical components of the propeller blade is provided in the same manner as for the power transmission system shown in FIG. 1 to 4. In particular, the inner conductive shaft 200 of the rotatable shaft 50 extends axially beyond the end of the outer conductive shaft 100. The end of the inner conductive shaft 200 is then configured to contact the conductive cap 160 so that the conductive cap 160 has the same electrical potential as the second electrical terminal at the aircraft end.

The conductive cap 160 comprises an axially extending circumferential flange 150a, 150b which extends toward the propeller. The circumferential flange 150a, 150b is configured to contact the conductive ring 2 of the power transmission system 20. The conductive ring 2 therefore comprises the same electrical potential as the inner conductive shaft 100 of the rotatable shaft. The conductive ring 2 is then connected to the second electrical terminal of the propeller electrical components 210 via the connectors 9a, 9b. This arrangement provides an electrical pathway between the second electrical terminal of the electrical power source at the aircraft end and the second electrical terminal of the propeller electrical components 210.

1-25. (canceled)

26. A power transmission system for a propeller hub of an aircraft, the power transmission system comprising:
a hollow insulating cylinder configured to be mounted to a rotatable shaft;
a first conductive element positioned on a first end surface of the insulating cylinder; and
a second conductive element positioned on a second end surface of the insulating cylinder;
wherein the first conductive element is configured to be connectable to a second electrical terminal of electrical components on a propeller of the aircraft, and the second conductive element is configured to be connectable to a first electrical terminal of electrical components of a propeller of the aircraft.

27. The power transmission system as claimed in claim 26, wherein the insulating cylinder comprises a first recess within the first end surface of the insulating cylinder housing the first conductive element, and a second recess within the second end surface of the insulating cylinder housing the second conductive element.

28. The power transmission system as claimed in claim 27, wherein the first recess and second recess are both sized such that the first conductive element and second conductive element is flush with the respective end surface of the insulating cylinder.

29. The power transmission system as claimed in claim 27, wherein the first recess and second recesses are located at a radial position which is proximate the outer circumference of the respective end surfaces.

30. The power transmission system as claimed in claim 27, wherein the first recess and second recess are spaced radially inwardly from the outer circumference of the respective end surface.

31. The power transmission system as claimed in claim 27, wherein the first end of the insulating cylinder comprises a first flange providing the first end surface and the second end of the insulating cylinder comprises a second flange providing the second surface, wherein first recess and second recess are within the respective end surfaces provided by the respective flanges.

32. The power transmission system as claimed in claim 31, wherein an aperture is provided through an inner surface of each of the first and second recesses to provide access to the respective first and second conductive elements.

33. The power transmission system as claimed in claim 26, wherein the first conductive element is connectable to a second electrical terminal of electrical components of the propeller by a first electrical wire, and the second conductive element is connectable to a first electrical terminal of electrical components of the propeller by an electrical wire.

34. The power transmission system as claimed in claim 33, wherein each of the first conductive element and second conductive element are connectable to the respective electrical terminals by an electrical wire via the respective apertures.

35. The power transmission system as claimed in claim 26, wherein the first conductive element is a first conductive ring and the second conductive element is a second conductive ring.

36. The power transmission system as claimed in claim 26, comprising an inner cylinder concentric with the insulating cylinder and located radially inwardly of the insulating cylinder.

37. The power transmission system as claimed in claim 36, wherein the insulating cylinder is configured to be mounted to the rotatable shaft via the inner cylinder.

38. A propulsion system for a propeller of an aircraft comprising:
a rotatable shaft for transmission of mechanical power extending from an aircraft end to a propeller end,
aircraft end electrical connection at the aircraft end of the rotatable shaft for connection to first and second electrical terminals of an electrical power source,
wherein the shaft comprises an inner conductive shaft connectable to a second electrical terminal of the electrical power source, an outer conductive shaft connectable to a first electrical terminal of the electrical power source, and an insulator positioned between the inner conductive shaft and the outer conductive shaft, and
wherein the propulsion system further comprises:
a power transmission system as claimed in claim 26 at the propeller end of the rotatable shaft configured to provide electrical connection to the first and second electrical terminals for supplying power to electrical components of the propeller from the electrical power source.

39. The propulsion system as claimed in claim 38, wherein the power transmission system is arranged to provide a first electrical pathway between the first electrical terminal of the power source at the aircraft end of the rotatable shaft and the first electrical terminal of the electrical components of the propeller, and a second electrical pathway between the second electrical terminal of the power source at the aircraft end of the rotatable shaft and the second electrical terminal of the electrical components of the propeller.

40. The propulsion system as claimed in claim 38, comprising an electrically conductive propeller mounting component configured to mount the propeller to the rotatable shaft and provide an electrical connection between the outer conductive shaft of the rotatable shaft and the second conductive element.

41. The propulsion system as claimed in claim 38, wherein the electrically conductive propeller mounting component is arranged in direct contact with the outer conductive shaft of the rotatable shaft and the second conductive element.

42. The propulsion system as claimed in claim 38, wherein the electrically conductive propeller mounting component is arranged to rotate with the rotatable shaft in use such that the relative position of the electrically conductive propeller mounting component and the second conductive element remains constant.

43. The propulsion system as claimed in claim 38, comprising an electrically conductive cap mounted at an axial end of the rotatable shaft proximate the propeller end, wherein the electrically conductive cap is arranged to provide an electrical connection between the inner conductive shaft of the rotatable shaft and the first conductive element.

44. The propulsion system as claimed in claim 43, wherein the inner conductive shaft extends to an axial end beyond the axial end of the outer conductive shaft, wherein the electrically conductive cap is arranged direct contact with the axial end of the inner conductive shaft and the first conductive element.

45. The propulsion system as claimed in claim 43, wherein the electrically conductive cap comprises a first surface arranged in contact with the axial end of the inner conductive shaft, and a flange portion extending parallel to a longitudinal direction of the rotatable shaft in contact with the first conductive element.

46. The propulsion system as claimed in claim 44, wherein the conductive cap comprises a cavity arranged to house the axial end of the inner conductive shaft.

47. A method for providing electrical power to a propeller using a power transmission system as claimed in claim 26, the method comprising:
mounting an insulating cylinder to a rotatable shaft for transmission of mechanical power to the propeller hub;
providing a first conductive element on a first end surface of the insulating cylinder;
providing a second conductive element on a second end surface of the insulating cylinder;
connecting the first conductive element to a second electrical terminal of electrical components on a propeller of the aircraft; and
connecting the second conductive element to a second electrical terminal of the propeller of the aircraft.
